(19) United States
(12) Patent Application Publication
(10) Pub. No.: US 2020/0364270 A1
(43) Pub. Date: Nov. 19, 2020

(54) FEEDBACK-BASED IMPROVEMENT OF COSINE SIMILARITY

(71) Applicant: General Electric Company, Schenectady, NY (US)

(72) Inventor: Abhay HARPALE, San Ramon, CA (US)

(21) Appl. No.: 16/411,659

(22) Filed: May 14, 2019

(51) Int. Cl. G06F 16/9032; G06N 20/00; G06F 17/27; G06F 17/11; G06F 16/93

(52) U.S. Cl. CPC G06F 16/90332; G06N 20/00; G06F 16/93; G06F 17/11; G06F 17/27

(57) ABSTRACT

According to some embodiments, system and methods are provided comprising receiving, via a communication interface of a matching module comprising a processor, a dataset including two or more elements, wherein each of the two or more elements is one of a word and a document including one or more words; assigning at least one weight to each word in the dataset; calculating a weighted similarity score between two or more elements based on the assigned weight; determining whether the weighted similarity score is approved or rejected; and receiving the weighted similarity score at at least one of a user and another system. Numerous other aspects are provided.

### BACKGROUND

In machine learning (ML), a common task is text mining (e.g., process of deriving information from text). The information may be derived by determining patterns and trends in the text. For example, a situation where text mining may be used is when a piece of electronic mail (e-mail) is received and a system or user wants to determine whether the e-mail should be classified as SPAM (i.e. unsolicited or undesired electronic message). To determine whether this known piece of e-mail is SPAM or not, a similarity metric may be used to analyze the content (i.e. text) of the e-mail. The analysis may include the comparison of the content of the e-mail to a known piece of text that is SPAM and a determination of how similar the text of the received e-mail is to the text of the SPAM e-mail. The more similar the two texts are, the more likely that the received e-mail is SPAM.

A common similarity metric for computing a similarity score between two observations or texts is cosine similarity. For the calculation of cosine similarity, the observation/texts may be represented as vectors. Additionally, known examples of the subject of analysis is also encoded as a vector. Continuing with the example above, known text that has been designated as SPAM may also be encoded as a vector. Then the cosine between the two vectors (observation vector and known vector) may be compared with the vectors being presented in n-dimensional space. The smaller the angle between the two vectors, the higher the similarity. However, cosine similarity conventionally works by assigning an equal weight to each element of the vectors being compared, may be unsuitable for learning from feedback, and may only compare vectors element-wise (e.g., only searches for exact matches of words).

Therefore, it would be desirable to provide a system and method that improves the cosine similarity metric.

### BRIEF DESCRIPTION

According to some embodiments, a method includes receiving, via a communication interface of a matching module comprising a processor, a dataset including two or more elements, wherein each of the two or more elements is one of a word and a document including one or more words; assigning at least one weight to each word in the dataset; calculating a weighted similarity score between two or more elements based on the assigned weight; determining whether the weighted similarity score is approved or rejected; and receiving the weighted similarity score at at least one of a user and another system.

According to some embodiments, a system includes a matching module including a processor; and a memory storing program instructions, and the matching module operative with the program instructions to perform the functions as follows: receive, via a communication interface of a matching module comprising a processor, a dataset including two or more elements, wherein each of the two or more elements is one of a word and a document including one or more words; assign at least one weight to each word in the dataset; calculate a weighted similarity score between two or more elements based on the assigned weight; determine whether the weighted similarity score is approved or rejected; and receive the weighted similarity score at at least one of a user and another system.

According to some embodiments, a non-transitory computer readable medium stores instructions that, when executed by a computer processor, cause the computer processor to perform a method including: receiving, via a communication interface of a matching module comprising a processor, a dataset including two or more elements, wherein each of the two or more elements is one of a word and a document including one or more words; assigning at least one weight to each word in the dataset; calculating a weighted similarity score between two or more elements based on the assigned weight; determining whether the weighted similarity score is approved or rejected; and receiving the weighted similarity score at at least one of a user and another system.

A technical effect of some embodiments of the invention is an improved technique and system for extension of the cosine similarity metric by including a weighted vector. The weighted vector may be such that every term has a weight associated therewith, and every cross-term (e.g., pair of words that mean the same or opposite—e.g., good and great or good and bad) has a weight associated therewith. Embodiments provide for a cosine similarity metric that learns gradually from feedback and weights of the elements, as well as the interactions between the elements. Embodiments provide for the automatic tuning of the similarity metric based on feedback. Embodiments provide for inter-word weighting, a process for seeding such weights. By including the weighted measure, one or more embodiments may provide for customization of the similarity metric for a given subject. As a non-exhaustive example, conventionally, the same cosine similarity may be applied to texts of emails in the SPAM example provided above, and a situation of building a domain to classify a document as a sports or non-sports document. With one or more embodiments, on the other hand, the weighting of the vector may customize the similarity metric to focus on a particular subject.

With this and other advantages and features that will become hereinafter apparent, a more complete understanding of the nature of the invention can be obtained by referring to the following detailed description and to the drawings appended hereto.

Other embodiments are associated with systems and/or computer-readable medium storing instructions to perform any of the methods described herein.

### DRAWINGS

FIG. 1 illustrates a flow diagram according to some embodiments.

FIG. 2 illustrates a block diagram of a process according to some embodiments.

FIG. 3 illustrates a system according to some embodiments.

FIG. 4 illustrates a block diagram of a system according to some embodiments.

### DETAILED DESCRIPTION

Conventional cosine similarity is one of the most widely used similarity metrics in machine learning (ML). Conventionally, cosine similarity of two n-dimensional real-valued vectors x and y is computed as the dot product of their unit vectors, as shown below:

$$cos ( x , y ) = \frac{{xy}^{T}}{‖ x ‖ ‖ y ‖}$$

However, as described above, cosine similarity assigns equal weights to elements in the vector, may ignore cross-term relations, and may not be amenable to feedback-based learning. As a non-exhaustive example, “he is a good person,” “he is nice” and “he is bad” will receive almost the same similarity scores/values using conventional cosine similarity, because the sentences share the segment “he is”, which are non-informative for their meaning. As described below, one or more embodiments provide for the terms “good”, “nice”, and “bad” to be weighted appropriately for comparison.

In one or more embodiments, a matching module may assign weights to the elements in the vector, resulting in a weighted vector. The weighted vector may then be used in the cosine similarity computation to determine a similarity between two vectors. The matching module may learn gradually from feedback associated with the weights of the vector elements and also the interactions between them. Continuing with the non-exhaustive example, when feedback is provided that “he is a good person” and “he is nice” mean the same thing, the matching module may automatically learn the inter-term associations of “good” and “nice”, and may assign them higher weights, but downplay the effect of “he is” because of the negative feedback received on “he is a good person” and “he is bad,” suggesting that “he is” is not the informative or important component of this sentence.

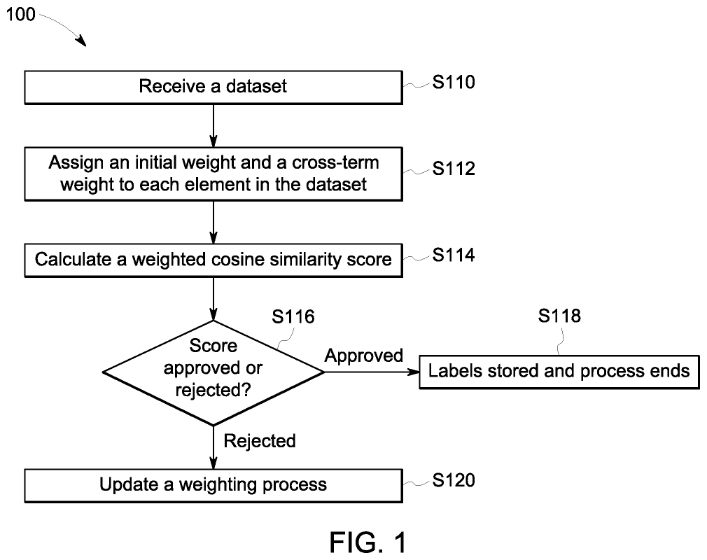

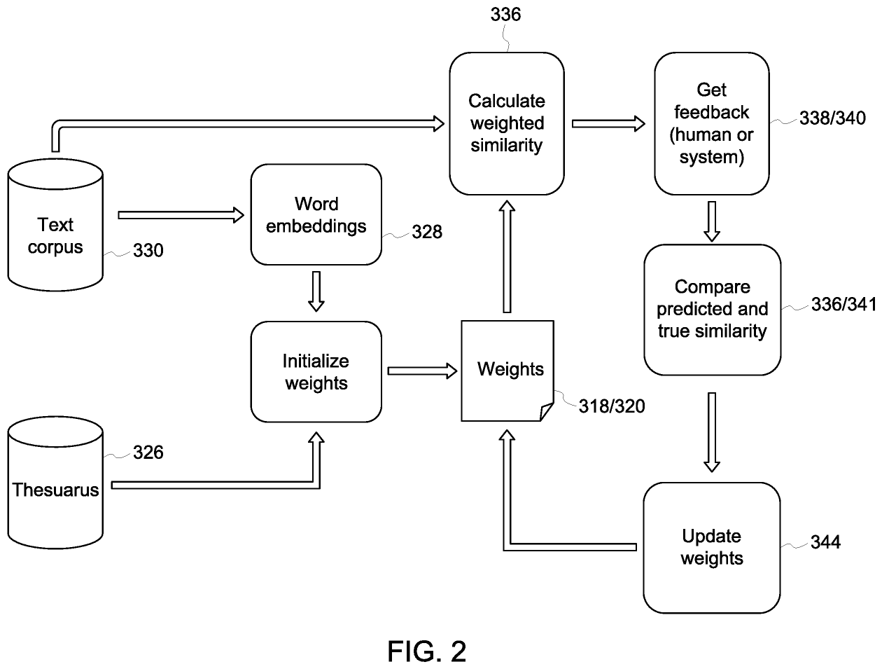

Turning to FIGS. 1-3, a system 300 and diagrams of examples of operation according to some embodiments are provided. In particular, FIG. 1 provides a flow diagram of a process 100, according to some embodiments. Process 100 and other processes described herein may be performed using any suitable combination of hardware (e.g., circuit(s)), software or manual means. In one or more embodiments, the system 300 is conditioned to perform the process 100 such that the system is a special-purpose element configured to perform operations not performable by a general-purpose computer or device. Software embodying these processes may be stored by any non-transitory tangible medium including a fixed disk, a floppy disk, a CD, a DVD, a Flash drive, or a magnetic tape. Examples of these processes will be described below with respect to embodiments of the system, but embodiments are not limited thereto.

Initially at S110, an initial dataset 302 is received at the matching module 304 to assign initial weights to two or more elements 306 in the initial dataset 302. Each of the two or more elements 306 may be a word/term 308 or a document 310. The document 310 may include one or more words/terms 308. As used herein, “word” and “term” may be used interchangeably. The initial dataset 302 may be used to initialize the training of the matching module 304 for a particular subject. The initial dataset 302 may include a knowledge-about-language subset 312 and a similarity score subset 314. The knowledge-about-language subset 312 may include two or more words with relationships that have been confirmed. For example, the knowledge-about-language subset 312 may include a listing for each word 308 of synonyms and antonyms, or the degree of relationship (e.g., good/nice/better/best may conceptually be the same, but to varying degrees). The similarity score subset 314 may include two or more documents 310, the similarity of which has been confirmed, and a confirmed similarity score 316 has been assigned to the two or more documents. As a non-exhaustive example, the similarity score subset 314 may include two communication skill course descriptions offered by two different vendors.

Then, in S112, an initial weight 318 and a cross-term weight 320 is assigned via a weighting process 322 of the matching module 304.

In one or more embodiments, with respect to the knowledge-about-language subset 312, each term 308 receives an initial weight 318 and a cross-term weight 320, where the cross-term weight is also associated with another term. It is noted that the cross-term weight suggests the semantic nearness or relatedness of two terms, so the cross-term weight is shared between the corresponding two terms. The weight may be a composite number that quantifies the semantic relatedness of the two terms. As used herein, “cross-term” may refer to two terms that mean the same thing. For example, “President of the United States,” and “POTUS” may be cross-terms. In one or more embodiments, the cross-term weight 320 may be: higher when two words have the same meaning (e.g., are semantically related); lower when the words are less semantically related, and zero if the words have zero semantic relationship (e.g., have no similarity). It is noted that in other embodiments, the cross-term weight 320 may be: lower when two words have the same meaning; higher if the words are less semantically related, and zero if the words have no semantic relationship.

In one or more embodiments, the weight (initial or cross-term) may be denoted by a weight matrix W. In the weight matrix, each diagonal element, for example W_{i,x},∀i is the weight associated with the i-th term. Each non-diagonal element W_{i,j} is the cross-term weight 320 between the i-th and j-th term. Using the diagonal element and non-diagonal elements, the weighted cosine similarity formula 324 is

$$w cos ( x , y , W ) = \frac{{xWW}^{T} {y}^{T}}{‖ xW ‖ ‖ yW ‖}$$

where “x” and “y” are the elements whose similarity is being computed and “T” denotes a matrix transpose operation.

It is noted that if the weight matrix is an identity matrix, that is W=I, such that W_{i,i}=1,∀i and W_{i,j}=0, ∀i≠j then the computation of the weighted cosine similarity formula 324, via the matching module 304, computes the standard/conventional cosine similarity. In one or more embodiments, with the computation of the weighted cosine similarity formula 324, documents may be represented as vectors, each position of the vector encoding a value of a word.

In one or more embodiments, the weighting process 322 may include at least one of several approaches to initializing the weight for use in the weighted cosine similarity formula 324. As noted above, a first process may be to initialize the weights to an identity matrix, W=I.

A second process may be related to the knowledge-about-language subset 312, as the second process may include the use of a listing of synonyms and antonyms 326 of words in a given language. A non-exhaustive example of the listing of synonyms and antonyms 326 is a thesaurus. With this process, each word 308 may be deemed semantically related to itself, so the diagonal elements are 1. This means W_{i,i}=1,∀i. All words that are listed as synonyms (e.g., similar in meaning) of a word receive an equal fraction of the weight. When a word i has nᵢ synonyms Sᵢ={j₁, . . . , jₙ_{ᵢ}}, then the corresponding non-diagonal elements are determined via

$${W}_{i , j} = \frac{1}{{n}_{i}} ∀ j ∈ {𝕊}_{i} .$$

The weighting process 322 may assign the initial weight 318 and the cross-weight 320 to the words based on the degree of relationship between the words per the data received with the knowledge-about-language subset 312. Initially, the weight 318 for each word is one (1). In one or more embodiments, when the weight equals one (1), the words 308 are identical, and the range of weight 318 may be bounded by one and zero, with zero meaning the words have no relation. As used herein, weight is a term-specific or cross-term weight, which may intuitively measure the nearness of two words in usage or semantics. The output of the weighted cosine similarity formula is an aggregate score (“weighted cosine similarity score”) for comparing the closeness of two documents (which are collections of words). It is noted that it is possible to apply the weighted cosine similarity formula to determine a similarity between a word and a document. A single word may be equivalent to a document with just one word in it and may be represented as such. The weights may interact with document-specific vectors to arrive at weighted vectors (×W in the above equation), and then may be manipulated together to arrive at a weighted cosine similarity score. Other suitable numbers and/or metrics may be used. Initially, the cross-term weight 320 for each pair of words is zero.

It is noted that while initially the weight may be zero, this zero weight may be supplemented with prior knowledge. For example, if there is knowledge about synonyms and antonyms, as described above, then that may guide the initialization of the cross-term weight. As further described below, if there is a word2vec embedding, that may adjust the initialization of the cross-term weights too.

A third process may be related to the similarity score subset 314. The third process may use a word-embeddings process 328 to initialize the weights of the words. As used herein, “word embeddings” may refer to vector representations of a particular word. With word-embeddings, a vector is created to represent each word and it measures the context in which a word may be used. In one or more embodiments, word-embeddings may be used to initialize cross-term weights in the absence of a thesaurus. It is noted that the word-embedding of a word indicates the context for the word. Words that are semantically related share similar context. As a non-exhaustive example, if the word-embedding of words “good” and “nice” are compared, the word-embeddings are quite close. As such, a comparison of word-embeddings of two words may provide clues about their relatedness in the absence of a thesaurus. The word-embedding process 328 may receive a text corpus 330 as input, and output a set of vectors, wherein the set of vectors includes a feature vector for each word in the text corpus. The text corpus 330 may be received as the initial data set including two or more documents, in one or more embodiments. As used herein, “text corpus” may refer to a large and structured set of texts (either electronically stored and processed or non-electronically stored). A non-exhaustive example of a word-embedding process is word2vec. In one or more embodiments, the word-embedding process 328 may use a large text corpus 330 that is relevant to a given subject to infer embeddings of words. In one or more embodiments, words with similar embeddings (e.g., vector positions in n-dimensional space) are usually used in similar context. For example, if vᵢ and vⱼ denote the vectors representing the embeddings of the words i and j respectively, the matching module 304 may find the similarity of these two vectors using the conventional cosine similarity metric cos (vᵢ, vⱼ). The matching module 304 may then use the similarity of the word-level embeddings to initialize the weight matrix, as follows:

$${W}_{i , j} = cos ( {v}_{i} , {v}_{j} )$$

It is noted that the cosine similarity, and weighted cosine similarity, of a vector with itself is one, cos (vᵢ, vⱼ)=1, and that the cosine similarity, and weighted cosine similarity, between any two words is bounded in the range [0,1].

With respect to the similarity score subset 314, the weighting process 322 may receive the two or more documents, and may assign each word within each document: 1. an identifier 332 for the word, and 2. a frequency value 334 indicative of the frequency with which the word is present in the document. The frequency value 334 may be a term-frequency-inverse document frequency value, which is a numerical statistic that is intended to indicate how important a word is to a document in a text corpus 330. Then, the weighting process 322 applies a weight multiplier to the vector representation of the text document, and outputs a weighted vector.

Turning back to the process 100, after the initial weight 318 and cross-term weight 320 are assigned in 212, a weighted cosine similarity score 336 is calculated in S114 for the two or more documents 310 in the text corpus 330, using the weighted cosine similarity formula 324, described above. In one or more embodiments, when the calculated weighted cosine similarity score 336 exceeds a threshold value, the documents being analyzed are labeled as one of similar (e.g. “match”) or dissimilar (“mis-match”). In one or more embodiments, the matching module 304 calculates the similarity between two documents, and the calculated match/mis-match may be used to update the weights of individual words or cross-term weights using an update function 344, described further below.

Then, in S116, the calculated weighted cosine similarity score 336 is analyzed, and a determination is made whether the weighted cosine similarity score 336 is approved or rejected. In one or more embodiments, the calculated weighted cosine similarity score 336 may be received by one of a user 338 and another system 340, and the user or another system may perform the analysis. As described above, the weighted cosine similarity score 336 may indicate a match or mis-match, based on the threshold value 342. The user/other system may review the two documents being compared and determine whether they are similar or not. The output of the user/other system may be considered a “true similarity score” 341. Then the user/other system may determine whether their determination matches the matching-module-determination, indicated by the labeled “match” or “mis-match.” In one or more embodiments, the user/other system may determine the calculated similarity score is accurate when the similarity between the weighted calculated similarity score and the true similarity score falls one of inside or outside of a predetermined threshold value or range of values. It is noted that either the predetermined individual threshold value or range of threshold values may be referred to as a “threshold value”. In one or more embodiments the analysis may result in the calculated weighted cosine similarity score 336 being one of approved or rejected.

As described above, the weighted cosine similarity score of the two documents is computed as a sum over the product of corresponding elements of the weighted vectors of two documents arising from the weighting process 322. As used herein, the terms “score” and “value” may be used interchangeably. The matching module 304 may then compare the matching-module-determined similarity score (e.g., predicted or estimated similarity score) of the two documents to the confirmed similarity score (or the true similarity score 341). In one or more embodiments, the true similarity score 341 may be received with the similarity score subset 314. In one or more embodiments, the matching module 304 may update the weights when there is a discrepancy between the predicted similarity score and the true similarity score, where the discrepancy exceeds a threshold value or range of threshold values. For example, consider the case where the predicted cosine similarity score is zero (suggesting that the two documents are dissimilar) while the true similarity score is one (implying that the two documents are a close match). This discrepancy may be addressed by adjusting the weights via an update function 344 to correct the discrepancy. The update function 344 may be applied to the weights when the weights do not lead to a match after initialization using the thesaurus or word-embeddings. The update function 344 may also be used to constantly improve the weights from continuous learning via feedback received from an end user.

When, in S116, the weighted cosine similarity is approved, the weights learned through the update function 344 may be stored in a storage device in S118, and the training process ends. Note however that in a deployment similarity scoring system, the feedback may be continually received from human annotators/end users and the weights may be continually adjusted for the life of the said system. It is also noted that in one or more embodiments, if the labels are the same (e.g., both “match”), the labels may not be stored as they are already part of the dataset being analyzed, which is invariable on a persistent storage device. In one or more embodiments, the weights calculated, as described herein, may be persisted and stored for later use.

When, in S116, the weighted cosine similarity score 336 is rejected, the process 100 proceeds to S120 and the weighting process 322 is updated via the update function 344 in the matching module 304.

The input to the update function 344 may be x, y, W, c. Here, x and y are the vectors whose similarity is being computed. The learned weights are denoted by W. It is noted that the current weight may be “W”. As such, after initialization, there is a certain weight matrix “W”. This weight matrix may undergo updates due to the update function 344, every time there is a mismatch between matching-module-determined weighted cosine similarity score (“predicted” or “estimated”) and true similarity scores. The continually updated weight matrix is the weight learned so far (learned weight). The desired weighted cosine similarity score between the two vectors, as provided by a user or another system is c. In one or more embodiments, the update function 344 may include five steps:

Step 1: Predict weighted cosine similarity:

ĉ=w cos(x,y,W)

Step 2: Compute error from true cosine similarity (as supplied via analysis)

$$δ = c - \hat{c}$$

Step 3: Compute gradient of the error with respect to W.

$$∇ ( δ ) = 2 \frac{xWy}{‖ xW ‖ ‖ yW ‖} - 2 \frac{cos ( x , y )}{‖ xW ‖ ‖ yW ‖} ( ‖ yW ‖ \frac{x ⊙ x}{‖ xW ‖} + ‖ xW ‖ \frac{y ⊙ y}{‖ yW ‖} ) ⊙ W$$

Step 4: Include a regularization term in the gradient

∇(δ,W)=−2δ∇(δ)+λW

Step 5: Standard Stochastic Gradient Descent (SGD) Update:

W=W−η∇(δ,W)

It is noted that SGD is an optimization algorithm for arriving at values of unknown variables that may lead to the optimal value of some function. In one or more embodiments, the unknown variable may be the “weights” and the optimal value being sought maybe the reduction in the mismatch between true and predicted similarity scores. The optimal value may be when the mismatch is zero or minimized. Other suitable optimization algorithms may be used. The steps of the update function 344 may be repeated for all pairs of documents with known (“true”) similarity scores in the text corpus until a desired accuracy rate of the weighted cosine similarity score 336 is reached. It is noted that in a deployed system, the update function may be performed in the background of the deployed system when a user/other system suggests that two documents are similar or dissimilar. The matching module 304 in the deployed system may then perform the update function to update the weights to satisfy the feedback received from the user/other system.

In one or more embodiments, once the weighted cosine similarity score is approved (e.g., S116) and the training process 100 ends (e.g., S118), the matching module 304 continues to receive new elements as a deployed system. It is noted that the matching module 304 may be useful in a deployed system when the confirmed similarity score/feedback is also passed in the system. Continuing with the non-exhaustive example described above regarding the courses, the system has assigned weights to the courses included in the text corpus, and the weights have been approved. At a future time, a new course is received. Because the matching module 304 is trained, it may analyze the new course to determine whether the new course is similar to the other courses in the text corpus. In one or more embodiments, in the deployed system, the matching module 304 may output a weighted cosine similarity score 336 for the new course via application of the weighted cosine similarity formula 324 described above.

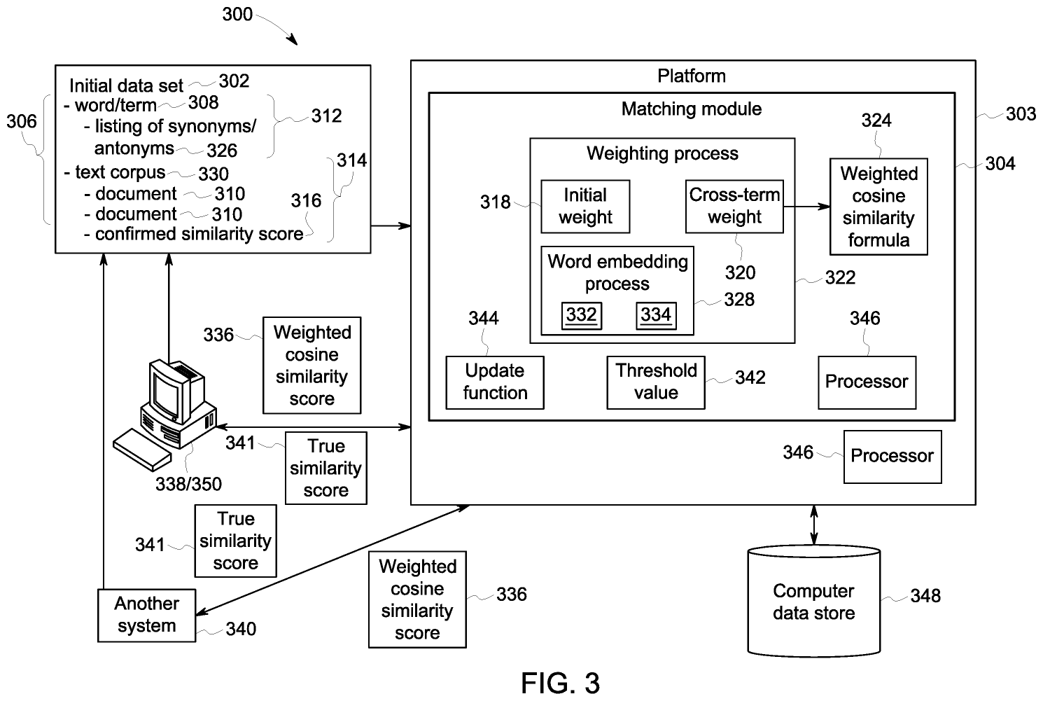

FIG. 3 is a block diagram of system architecture 300 according to some embodiments. Embodiments are not limited to architecture 300.

In one or more embodiments, the system 300 may include a memory/computer data store 348 and a platform 303 including one or more processing elements 346 and the matching module 304. It is noted that in some embodiments, the matching module 304 may include its own processor. The processor 346 may, for example, be a microprocessor, and may operate to control the overall functioning of the matching module 304. In one or more embodiments, the matching module 304 may include a communication controller for allowing the processor 346, and hence the matching module 304, to engage in communication over data networks with other devices.

In one or more embodiments, the system 300 may include one or more memory and/or data storage devices 348 that store data that may be used by the module. The data stored in the data store 348 may be received from disparate hardware and software systems associated with the system, or otherwise, some of which are not inter-operational with one another. The systems may comprise a back-end data environment employed by a business, industrial or personal context.

In one or more embodiments, the data store 348 may comprise any combination of one or more of a hard disk drive, RAM (random access memory), ROM (read only memory), flash memory, etc. The memory/data storage devices 348 may store software that programs the processor 346 and the matching module 304 to perform functionality as described herein.

As used herein, devices, including those associated with the system 300 and any other devices described herein, may exchange information and transfer input and output (“communication”) via any number of different systems. For example, wide area networks (WANs) and/or local area networks (LANs) may enable devices in the system to communicate with each other. In some embodiments, communication may be via the Internet, including a global internetwork formed by logical and physical connections between multiple WANs and/or LANs. Alternately, or additionally, communication may be via one or more telephone networks, cellular networks, a fiber-optic network, a satellite network, an infrared network, a radio frequency network, any other type of network that may be used to transmit information between devices, and/or one or more wired and/or wireless networks such as, but not limited to Bluetooth access points, wireless access points, IP-based networks, or the like. Communication may also be via servers that enable one type of network to interface with another type of network. Moreover, communication between any of the depicted devices may proceed over any one or more currently or hereafter-known transmission protocols, such as Asynchronous Transfer Mode (ATM), Internet Protocol (IP), Hypertext Transfer Protocol (HTTP) and Wireless Application Protocol (WAP).

In some embodiments, the system 300 may also include a communication channel to supply output (e.g., match or mis-match) from the matching module 304 to at least one of: user 338/user platforms 350, or to other systems 340. In some embodiments, received output from the matching module 304 may cause modification in the state or condition of the system 300. The user 336 may access the system 300 via one of the user platforms 350 (a control system, a desktop computer, a laptop computer, a personal digital assistant, a tablet, a smartphone, etc.) to view information about the data similarity in accordance with any of the embodiments described herein.

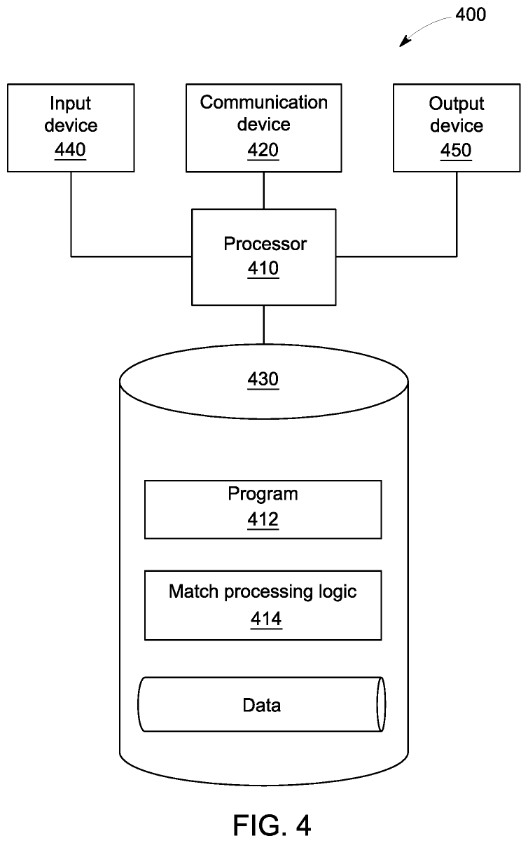

Note the embodiments described herein may be implemented using any number of different hardware configurations. For example, FIG. 4 illustrates a matching processing platform 400 that may be, for example, associated with the system 300 of FIG. 3. The matching processing platform 400 comprises a match processor 410 (“processor”), such as one or more commercially available Central Processing Units (CPUs) or Graphics Processing Units (GPUs) in the form of one-chip microprocessors, coupled to a communication device 420 configured to communicate via a communication network (not shown in FIG. 4). The communication device 420 may be used to communicate, for example, with one or more users. The matching processing platform 400 further includes an input device 440 (e.g., a mouse and/or keyboard to enter information about the dataset) and an output device 450 (e.g., to output and display the data and/or match/mis-match).

The processor 410 also communicates with a memory/storage device 430. The storage device 430 may comprise any appropriate information storage device, including combinations of magnetic storage devices (e.g., a hard disk drive), optical storage devices, mobile telephones, and/or semiconductor memory devices. The storage device 430 may store a program 412 and/or match processing logic 414 for controlling the processor 410. The processor 410 performs instructions of the programs 412, 414, and thereby operates in accordance with any of the embodiments described herein. For example, the processor 410 may receive input and then may apply the matching module 304 via the instructions of the programs 412, 414 to determine whether two elements are similar.

The programs 412, 414 may be stored in a compressed, uncompiled and/or encrypted format. The programs 412, 414 may furthermore include other program elements, such as an operating system, a database management system, and/or device drivers used by the processor 410 to interface with peripheral devices.

As used herein, information may be “received” by or “transmitted” to, for example: (i) the platform 400 from another device; or (ii) a software application or module within the platform 400 from another software application, module, or any other source.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein; by way of example and not limitation, a matching module. The method steps can then be carried out using the distinct software modules and/or sub-modules of the system, as described above, executing on one or more hardware processors 410 (FIG. 4). Further, a computer program product can include a computer-readable storage medium with code adapted to be implemented to carry out one or more method steps described herein, including the provision of the system with the distinct software modules.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

1. A method comprising:
receiving, via a communication interface of a matching module comprising a processor, a dataset including two or more elements, wherein each of the two or more elements is one of a word and a document including one or more words;
assigning at least one weight to each word in the dataset;
calculating a weighted similarity score between two or more elements based on the assigned weight;
determining whether the weighted similarity score is approved or rejected; and
receiving the weighted similarity score at at least one of a user and another system.

2. The method of claim 1, wherein the weighted similarity score is based on a cosine similarity measure.

3. The method of claim 1, wherein the data set includes a text corpus including two or more documents.

4. The method of claim 1, wherein the weighted similarity score is calculated for one of: two or more words, two or more documents, and a word and document.

5. The method of claim 1, wherein assigning at least one weight further comprises:
assigning a first weight to the word; and
assigning a second weight to a cross-term.

6. The method of claim 1, wherein determining whether the weighted similarity score is approved or rejected further comprises:
comparing the weighted calculated similarity score to a true similarity score; and
determining the calculated similarity score is accurate when the similarity between the weighted calculated similarity score and the true similarity score falls one of inside or outside of a predetermined value or range of values.

7. The method of claim 1, wherein calculating the weighted similarity score further comprises calculating a weighted cosine similarity formula.

8. The method of claim 7, wherein the weighted cosine similarity formula is:
$$w cos ( x , y , W ) = \frac{{xWW}^{T} {y}^{T}}{‖ xW ‖ ‖ yW ‖} .$$

9. The method of claim 1, further comprising:
updating the at least one weight when the similarity score is rejected.

10. The method of claim 9, wherein updating the at least one weight further comprises:
applying an optimization function to the at least one weight.

11. The method of claim 9, wherein updating the at least one weight further comprises:
calculating an error from the rejected similarity score and a true cosine similarity score;
calculating a gradient of the error with respect to the at least one weight used in the rejected similarity score, wherein the gradient includes a regularization term; and
applying an optimization function to the calculated gradient.

12. A system comprising:
a matching module including a processor; and
a memory storing program instructions, and the matching module operative with the program instructions to perform the functions as follows:
receive, via a communication interface of a matching module comprising a processor, a dataset including two or more elements, wherein each of the two or more elements is one of a word and a document including one or more words;
assign at least one weight to each word in the dataset;
calculate a weighted similarity score between two or more elements based on the assigned weight;
determine whether the weighted similarity score is approved or rejected; and
receive the weighted similarity score at at least one of a user and another system.

13. The system of claim 12, wherein the weighted similarity score is based on a cosine similarity measure.

14. The system of claim 12, wherein the data set includes a text corpus including two or more documents.

15. The system of claim 12, wherein assigning at least one weight further comprises program instructions to:
assign a first weight to the word; and
assign a second weight to a cross-term.

16. The system of claim 12, wherein instructions to determine whether the weighted similarity score is approved or rejected further comprises program instructions to:
compare the weighted calculated similarity score to a true similarity score; and
determine the calculated similarity score is accurate when the similarity between the weighted calculated similarity score and the true similarity score falls one of inside or outside of a predetermined value or range of values.

17. The system of claim 12, wherein instructions to calculate the weighted similarity score further comprise instructions to calculate a weighted cosine similarity formula of:
$$w cos ( x , y , W ) = \frac{{xWW}^{T} {y}^{T}}{‖ xW ‖ ‖ yW ‖} .$$

18. The system of claim 12 further comprising program instructions to:
update the at least one weight when the similarity score is rejected.

19. A non-transitory computer-readable medium storing instructions that, when executed by a computer processor, cause the computer processor to perform a method comprising:
receiving, via a communication interface of a matching module comprising a processor, a dataset including two or more elements, wherein each of the two or more elements is one of a word and a document including one or more words;
assigning at least one weight to each word in the dataset;
calculating a weighted similarity score between two or more elements based on the assigned weight;
determining whether the weighted similarity score is approved or rejected; and
receiving the weighted similarity score at at least one of a user and another system.

20. The medium of claim 19, wherein the weighted similarity score is based on a cosine similarity measure.
